(19) United States
(12) Patent Application Publication
(10) Pub. No.: US 2026/0085188 A1
(43) Pub. Date: Mar. 26, 2026

(54) Specific Benzopyrylium Salts as Dyestuffs for Photopolymer Compositions

(71) Applicant: Covestro Deutschland AG, Leverkusen (DE)

(72) Inventors: Lena Nault, Köln (DE); Thomas Roelle, Leverkusen (DE); Igor Pochorovski, Monheim am Rhein (DE); Thorben Koehler, Hilden (DE)

(21) Appl. No.: 19/109,161

(22) PCT Filed: Sep. 4, 2023
(86) PCT No.: PCT/EP2023/074128

§ 371 Date: Mar. 6, 2025

(30) Foreign Application Priority Data
Sep. 7, 2022 (EP) 22194271.7

(51) Int. Cl. C09B 23/01; G03H 1/02

(52) U.S. Cl. CPC C09B 23/0066; G03H 1/02; G03H 2001/0264; G03H 2260/12

(57) ABSTRACT

The disclosure relates to a benzopyrylium dye of the formula (I),

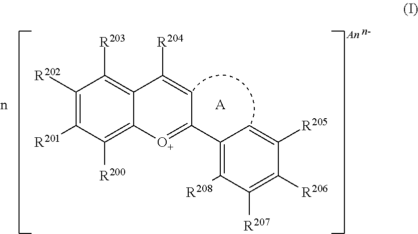

in which R²⁰⁰, R²⁰¹, R²⁰², R²⁰³, R²⁰⁴, R²⁰⁵, R²⁰⁶, R²⁰⁷ and R²⁰⁸ independently of one another are each hydrogen, C₁ to C₁₆ alkyl, C₄ to C₇ cycloalkyl, C₇ to C₁₆ aralkyl, C₆ to C₁₀ (het)aryl, hydroxyl, C₁ to C₆ alkoxy, or dialkylamino, the dialkylamino being selected from the group consisting of diethylamino, dimethylamino, diisopropylamino, a six-membered saturated ring attached via the N of the amino group, which may additionally contain an N or O and may be substituted by nonionic arbitrary radicals, or a combination of at least two thereof, and/or R²⁰⁰ with R²⁰¹ or R²⁰¹ with R²⁰² or R²⁰² with R²⁰³ and/or R²⁰⁵ with R²⁰⁶ and/or R²⁰⁶ with R²⁰⁷ each independently of one another form a —CH═CH—CH═CH— bridge, and A is a —CH₂— or a —CH₂—CH₂— bridge, where the anion Anⁿ⁻ has a molecular weight of ≥200 g/mol and does not contain a halogen atom.

### CROSS-REFERENCE TO RELATED APPLICATIONS

This application is the United States national phase of International Patent Application No. PCT/EP2023/074128 filed Sep. 4, 2023, and claims priority to European Patent Application No. 22194271.7 filed Sep. 7, 2022, the disclosures of which are hereby incorporated by reference in their entireties.

### BACKGROUND

### Technical Field

The invention relates to benzopyrylium dyes in the form of benzopyrylium salts, which can be used in particular as dyes in photopolymer compositions for holographic media. In addition, the synthesis of the specific benzopyrylium salts is disclosed, along with photopolymer compositions comprising at least matrix polymers, writing monomers and a photoinitiation system (PIS), wherein the PIS contains at least one benzopyrylium salt according to the invention as a dye, holographic media comprising matrix polymers, writing monomers and a PIS, wherein the PIS contains at least one benzopyrylium salt according to the invention as a dye, and also layer structures and displays comprising a holographic medium according to the invention, each of which is a subject of the invention.

### Description of Related Art

A wide variety of different photopolymer compositions are known in the prior art. For example, WO 2008/125229 describes a photopolymer composition and a photopolymer obtainable therefrom, comprising polyurethane matrix polymers, one or more acrylate-based writing monomers, and a PIS containing a co-initiator and at least one dye. In the context of uses of photopolymers, the refractive index modulation Δn generated by holographic exposure plays a decisive role. In holographic exposure, the interference field composed of signal light beam and reference light beam (that of two plane waves in the simplest case) is mapped into a refractive index grating by the local photopolymerization of writing monomers such as, for example, high-refractive-index acrylates at loci of high intensity in the interference field. The refractive index grating in the photopolymer (the hologram) contains all the information of the signal light beam. By illuminating the hologram with only the reference light beam, the signal can then be reconstructed. The strength of the signal thus reconstructed in relation to the strength of the irradiated reference light is called diffraction efficiency, hereinafter sometimes just DE.

In the simplest case of a hologram resulting from the superposition of two plane waves, the DE is the ratio of the intensity of the light diffracted on reconstruction to the sum total of the intensities of diffracted light and nondiffracted light. The higher the DE, the greater the efficiency of a hologram with regard to the amount of reference light needed to visualize the signal with a defined brightness. For many holographic applications of photopolymer compositions and the resultant holographic media, however, it is not just the holographic performance that plays an important role; it is also crucial that the media have an excellent bleachability, i.e., high transmission over the entire visible spectral range from 400 nm to 800 nm. This depends significantly on the dye used in the photoinitiator system of the photopolymer composition.

Suitable dyes for photopolymers have already been widely described; for example, a wide variety of different classes of cationic dyes are described in EP 2638544, and can be used as suitable sensitizers in interaction with co-initiators such as triarylalkylborate salts in photopolymer compositions. In addition to the aforementioned good bleachability, principal requirements for such dyes are a rapid initiation of a radical polymerization by electron or energy transfer with a suitable co-initiator and also good compatibility with the other components of the photopolymer composition, so as to avoid formation of inhomogeneities or turbidities in the photopolymer. According to EP 2638544, the following dye classes are highly suitable for photopolymers: acridine dyes, xanthene dyes, thioxanthene dyes, phenazine dyes, phenoxazine dyes, phenothiazine dyes, tri(het)arylmethane dyes—especially diamino—and triamino(het)arylmethane dyes, mono-, di- and trimethinecyanine dyes, hemicyanine dyes, externally cationic merocyanine dyes, externally cationic neutrocyanine dyes, zeromethine dyes—especially naphtholactam dyes, streptocyanine dyes. Dyes of this kind are also described, for example, in H. Berneth in Ullmann's Encyclopedia of Industrial Chemistry, Azine Dyes, Wiley-VCH Verlag, 2008, H. Berneth in Ullmann's Encyclopedia of Industrial Chemistry, Methine Dyes and Pigments, Wiley-VCH Verlag, 2008, T. Gessner, U. Mayer in Ullmann's Encyclopedia of Industrial Chemistry, Triarylmethane and Diarylmethane Dyes, Wiley-VCH Verlag, 2000.

However, it has been found that although these known dyes can achieve very good holographic performance, the bleachability criterion has not yet been satisfactorily met.

### SUMMARY

One object of the invention was therefore to provide a dye which at least partially overcomes one previously described disadvantage. Furthermore, it was an object of the present invention to provide a photopolymer composition of the type stated above which, after bleaching with the aid of a suitable radiation source, provides a particularly high transmission over the entire visible spectral range.

Surprisingly, it has been found that the use of certain benzopyrylium salts as dyes in photopolymer compositions of the type stated above allows a higher transmission over the entire visible spectral range from 400 nm to 800 nm to be achieved than with the dyes known to date, such as those from EP 2638544, for example.

A first subject of the invention relates to a benzopyrylium dye of the formula (I)

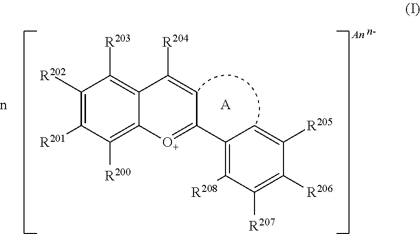

in which
R²⁰⁰, R²⁰¹, R²⁰², R²⁰³, R²⁰⁴, R²⁰⁵, R²⁰⁶, R²⁰⁷ and R²⁰⁸ independently of one another are each hydrogen, alkyl, preferably C₁ to C₁₆ alkyl, particularly preferably C₁ to C₁₀ alkyl, more preferably C₁ to C₆ alkyl, especially preferably C₁ to C₄ alkyl, most preferably methyl; cycloalkyl, preferably C₄ to C₇ cycloalkyl, particularly preferably C₅ to C₆ cycloalkyl, aralkyl, preferably C₇ to C₁₆ aralkyl, particularly preferably C₈ to C₁₂ aralkyl, aryl, preferably phenyl, (het)aryl, preferably C₆ to C₁₀(het)aryl, hydroxyl, alkoxy, preferably C₁ to C₆ alkoxy, particularly preferably methoxy, or dialkylamino,
A is a —CH₂— or a —CH₂—CH₂— bridge,
and the anion Anⁿ⁻ has a molecular weight of ≥200 g/mol and does not contain a halogen atom, where n is from 1 to 3. Further preferably, the anion Anⁿ⁻ has a molecular weight of 250 g/mol, more preferably of ≥300 g/mol, particularly preferably of ≥350 g/mol. It is preferred that the anion An⁻ has a molecular weight in a range from ≥200 g/mol to 1000 g/mol, more preferably from ≥250 g/mol to 900 g/mol, particularly preferably from ≥300 g/mol to 800 g/mol, especially preferably from ≥350 g/mol to 700 g/mol.

Preferably, R²⁰⁰ with R²⁰¹ or R²⁰¹ with R²⁰² or R²⁰² with R²⁰³ or R²⁰⁵ with R²⁰⁶ or R²⁰⁶ with R²⁰⁷ each independently of one another together form a —CH═CH—CH═CH bridge.

Preferably, the (het)aryl is an aryl radical which is substituted at least at one position by a heteroatom such as O, N, P, S or a combination thereof.

It is preferred that the dialkylamino is preferably a five- or six-membered saturated ring which is attached via the N of the amino group and which may additionally contain an N or O and/or may be substituted by nonionic radicals. The nonionic radicals are preferably selected from the group consisting of alkyl, alkoxy, hydroxyl, thiol, aryl, (het)aryl, amine, amide or a combination of at least two thereof.

Incidentally it has turned out that photopolymers enjoy particularly good bleachability in addition to high DE and Δn values, a rapid initiation of the radical polymerization and a high compatibility with other components of the photopolymer composition when at least one dye of the formula (I) is included in the photopolymer composition.

### BRIEF DESCRIPTION OF THE DRAWINGS

FIG. 1 shows the holographic test setup with which the diffraction efficiency (DE) of the holographic media was measured.

FIG. 2 shows the measured transmitted power P_{T} (right-hand y-axis) plotted as a solid line (here of Example 5) against the angle detuning ΔΩ, the measured diffraction efficiency η (left-hand y-axis) plotted as filled circles against the angle detuning ΔΩ (to the extent allowed by the finite size of the detector), and the fitting to the Kogelnik theory as a broken line (left-hand y-axis).

### DETAILED DESCRIPTION

In one preferred embodiment of the benzopyrylium dye of the formula (I), R²⁰⁰, R²⁰⁵, R²⁰⁷ and R²⁰⁸ are each hydrogen and A is a —CH₂—CH₂— bridge. Preferably, R²⁰¹, R²⁰², R²⁰³ and R²⁰⁶ independently of one another are a radical selected from the group consisting of hydrogen, C₁ to C₁₆ alkyl, C₄ to C₇ cycloalkyl, C₇ to C₁₆ aralkyl, C₆ to C₁₀(het)aryl, hydroxyl, C₁ to C₆ alkoxy or dialkylamino, R²⁰⁴ is a radical selected from the group consisting of hydrogen, C₁ to C₄ alkyl, or an arbitrarily substituted (het)aryl radical or R²⁰¹ with R²⁰² or R²⁰² with R²⁰³ together form a —CH═CH—CH═CH— bridge. The dialkylamino is preferably selected from the group consisting of diethylamino, dimethylamino, diisopropylamino, a six-membered saturated ring attached via the N of the amino group, which may additionally contain an N or O and may be substituted by nonionic arbitrary radicals, or a combination of at least two thereof.

In one particularly preferred embodiment of the benzopyrylium dye of the formula (I), R²⁰⁰, R²⁰⁵, R²⁰⁷ and R²⁰⁸ are hydrogen, A is a —CH₂—CH₂— bridge and R²⁰¹ is selected from the group consisting of hydrogen, C₁ to C₄ alkyl, hydroxyl, C₁ to C₄ alkoxy and dialkylamino, the dialkylamino being selected from the group consisting of diethylamino, dimethylamino, diisopropylamino, a six-membered saturated ring attached via the N of the amino group, which may additionally contain an N or O and may be substituted by nonionic arbitrary radicals, or a combination of at least two thereof, R²⁰² is hydrogen, C₁ to C₄ alkyl, hydroxyl or C₁ to C₄ alkoxy, R²⁰³ either is hydrogen or together with R²⁰² forms a —CH═CH—CH═CH— bridge, R²⁰⁴ is hydrogen, C₁ to C₄ alkyl, or an arbitrarily substituted (het)aryl radical, and R²⁰⁶ is hydrogen, hydroxyl or C₁ to C₄ alkoxy.

Further preferably, in one preferred embodiment of the benzopyrylium dye of the formula (I), R²⁰¹ is a radical selected from the group consisting of hydrogen, methyl, ethyl, methoxy, ethoxy, dimethylamino and diethylamino.

The following benzopyrylium dyes (III) to (VIII) are especially preferred:

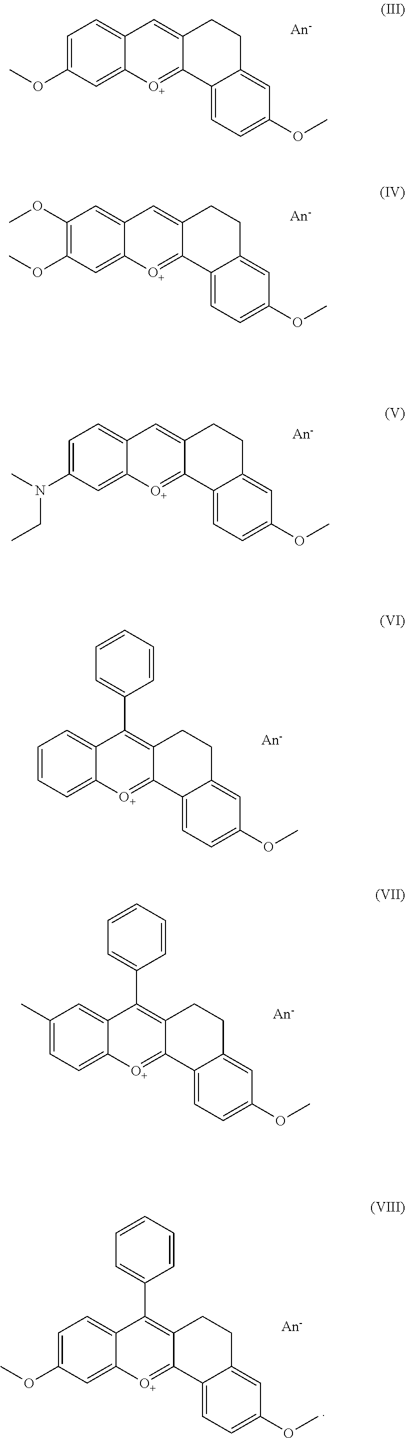

Preferably, the anion Anⁿ⁻, here with n=1, of the benzopyrylium cations described above is an anion with a molecular weight of ≥200 g/mol selected from the group of arbitrarily substituted phosphates, arbitrarily substituted phosphonates, arbitrarily substituted sulfonimides, arbitrarily substituted organic borates, such as tetraarylborate, triarylalkylborate or cyanotriarylborate, arbitrarily substituted alkyl or alkenyl sulfates, arbitrarily substituted mono- or di-sulfonates, such as sulfosuccinic esters, or the group of arbitrarily substituted organic mono- or di-carboxylates.

In one preferred embodiment of the benzopyrylium dye, the anion Anⁿ⁻ is selected from the group consisting of C₈ to C₂₅ alkanesulfonates, preferably C₁₃ to C₂₅ alkanesulfonates, C₉ to C₂₅ alkanoates, C₉ to C₂₅ alkenoates, C₈ to C₂₅ alkyl sulfates, preferably C₁₃ to C₂₅ alkyl sulfates, C₈ to C₂₅ alkenyl sulfates, preferably C₁₃ to C₂₅ alkenyl sulfates, polyether sulfates based on at least 5 equivalents of ethylene oxide or 5 equivalents of propylene oxide, bis-C₄ to C₂₅ alkyl-, C₈ to C₇ cycloalkyl-, C₃ to C₈ alkenyl- or C₇ to C₁₁ aralkyl-sulfosuccinates, C₈ to C₂₅ alkyl sulfoacetates, benzenesulfonates substituted by at least one radical of the group C₄ to C₂₅ alkyl and/or C₁ to C₁₂ alkoxycarbonyl, naphthalene- or biphenylsulfonates optionally substituted by nitro, cyano, hydroxyl, C₁ to C₂₅ alkyl, C₁ to C₁₂ alkoxy, amino or C₁ to C₁₂ alkoxycarbonyl, benzene-, naphthalene- or biphenyldisulfonates optionally substituted by nitro, cyano, hydroxyl, C₁ to C₂₅ alkyl, C₁ to C₁₂ alkoxy or C₁ to C₁₂ alkoxycarbonyl, benzoates substituted by dinitro, C₆ to C₂₅ alkyl, C₄ to C₁₂ alkoxycarbonyl, benzoyl or toluoyl.

Furthermore, the anion is preferably selected from the group of the anions of naphthalenedicarboxylic acid, diphenyl ether disulfonates, sulfonated or sulfated, optionally at least monounsaturated C₈ to C₂₅ fatty acid esters of aliphatic C₁ to C₈ alcohols or glycerol, bis(sulfo-C₂ to C₆ alkyl)-C₃ to C₁₂ alkanedicarboxylic esters, bis(sulfo-C₂ to C₆ alkyl)itaconic esters, (sulfo-C₂ to C₆ alkyl)-C₆ to C₁₈ alkanecarboxylic esters, (sulfo-C₂ to C₆ alkyl)acrylic or methacrylic esters, triscatechol phosphates, tetraphenylborates, cyanotriphenylborates, tetraphenoxyborates, C₄ to C₁₂ alkyl-triphenylborates, for which the phenyl or phenoxy radicals may be substituted by C₁ to C₄ alkyl and/or C₁ to C₄ alkoxy, C₄ to C₁₂ alkyl-trinaphthylborates, tetra-C₁ to C₂₀ alkoxyborates, singly or doubly negatively charged 7,8- or 7,9-dicarbanidoundecaborates, which are optionally substituted on the B and/or C atoms by one or two C₁ to C₁₂ alkyl or phenyl groups, doubly negatively charged dodecahydrodicarbadodecaborates or B—C₁ to C₁₂ alkyl-C-phenyldodecahydrodicarbadodecaborates, or a mixture of at least two thereof.

In one preferred embodiment of the benzopyrylium dye, the anion Anⁿ⁻ is selected from the group consisting of C₈ to C₂₅ alkanesulfonates, preferably C₁₃ to C₂₅ alkanesulfonates, C₈ to C₂₅ alkyl sulfates, preferably C₁₃ to C₂₅ alkyl sulfates, bis-C₄ to C₂₅ alkyl-, C₈ to C₇ cycloalkyl-, C₃ to C₈ alkenyl- or C₇ to C₁₁ aralkyl-sulfosuccinates, C₈ to C₂₅ alkyl sulfoacetates, benzenesulfonates substituted by at least one radical from the group C₄ to C₂₅ alkyl and/or C₁ to C₁₂ alkoxycarbonyl, and tetraphenyl borates, or a combination of at least two thereof.

The anion Anⁿ⁻ is preferably selected from the group consisting of bis-C₄ to C₂₅ alkylsulfosuccinates, C₄ to C₂₅ alkyl-substituted benzenesulfonates and tetraphenylborates.

The anion Anⁿ⁻ is particularly preferably selected from the group consisting of (2-ethylhexyl)sulfosuccinate, dodecylbenzenesulfonate and tetraphenylborate.

In one particularly preferred embodiment of the benzopyrylium dye, R200, R205, R207 and R208 are hydrogen, A is a —CH2—CH2— bridge, and
R201 is selected from the group consisting of hydrogen, C1 to C4 alkyl, hydroxyl, C1 to C4 alkoxy, or dialkylamino, the dialkylamino being selected from the group consisting of diethylamino, dimethylamino and diisopropylamino or a combination of at least two thereof, particularly preferably of hydrogen,
R202 is hydrogen, C1 to C4 alkyl, hydroxyl or C1 to C4 alkoxy, and particularly preferably is hydrogen,
R203 either is hydrogen or together with R202 forms a —CH═CH—CH═CH— bridge, and particularly preferably is hydrogen,
R204 is hydrogen or phenyl, and particularly preferably is hydrogen,
R206 is hydrogen, hydroxyl or C1 to C4 alkoxy, and particularly preferably is hydrogen, and
the anion Anⁿ⁻ is selected from the group consisting of C₈ to C₂₅ alkanesulfonates, preferably C₁₃ to C₂₅ alkanesulfonates, C₈ to C₂₅ alkyl sulfates, preferably C₁₃ to C₂₅ alkyl sulfates, bis-C₄ to C₂₅ alkyl-, C₈ to C₇ cycloalkyl-, C₃ to C₈ alkenyl- or C₇ to C₁₁ aralkyl-sulfosuccinates, C₈ to C₂₅ alkyl sulfoacetates, bis-C₄ to C₂₅ alkylsulfosuccinates, in particular (2-ethylhexyl)sulfosuccinate, C₄ to C₂₅ alkyl-substituted benzenesulfonates, in particular dodecylbenzenesulfonate, and tetraphenylborates, in particular tetraphenylborate, and particularly preferably selected from (2-ethylhexyl)sulfosuccinate, dodecylbenzenesulfonate and tetraphenylborates.

A further subject of the invention relates to a process for preparing a benzopyrylium dye, in particular a benzopyrylium dye according to the invention, comprising a multistage reaction sequence in which at least the reaction stages as follows are carried out:
A. In a first reaction stage P1.:
   P1.i. dissolving a correspondingly selected 2-hydroxyarylcarbonyl derivative together with a corresponding indanone or tetralone derivative in a weak acid, preferably glacial acetic acid;
   P1.ii. heating the mixture from P1.i. with the addition of a strong acid, the mixture being preferably brought at reflux to full conversion;
   P1.iii. cooling and washing the mixture from P1.ii. with a nonpolar aprotic solvent;
   P1.iv. separating the phase insoluble in the nonpolar aprotic solvent and taking up this phase in water;
B. in a second reaction stage P2.:
   P2.i. adding an alkali metal salt of the dye anion Anⁿ⁻ and a nonpolar aprotic solvent to the aqueous solution from P1.iv.,
   P2.ii. stirring and optionally heating the mixture from P2.i. and removing the aqueous phase and discarding it, including the salts contained,
P2.iii. washing the mixture from P2.ii. with water, preferably to the end point and
P2.iv. removing the solvent, optionally under reduced pressure, and drying the benzopyrylium dye according to the invention, optionally under reduced pressure.

In the event of precipitation of the dye after the first reaction stage P1., it is filtered off, washed with a nonpolar aprotic solvent and used as a purified product together with water in the second reaction stage P2. In the event of insolubility of the crude product in water, the oily phase containing crude product is washed with a nonpolar aprotic solvent in step P1.iv. and further processed together with water in the second reaction stage P2.

The benzopyrylium dye here is preferably prepared in a one-pot reaction according to the following reaction equation:

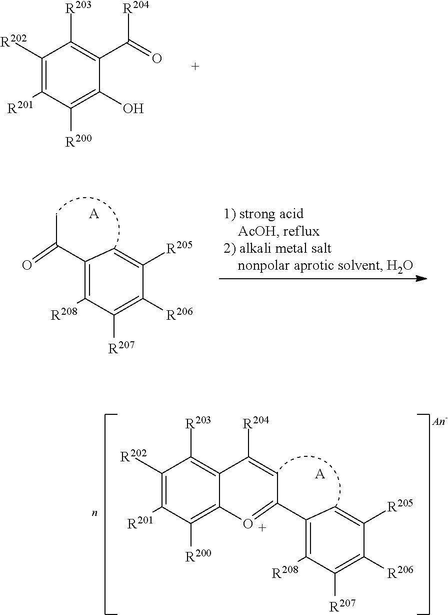

In the one-pot reaction regime, in a first reaction stage P1. the corresponding 2-hydroxyarylcarbonyl derivative is first dissolved in the equivalent ratio of 1:1 together with the corresponding indanone or tetralone derivative in glacial acetic acid in step P1.i. In step P1.ii., slowly, preferably in a period of 1 to 5 hours, a strong acid, preferably with a pKa value of ≤4, particularly preferably of ≤3, especially preferably of ≤2, most preferably of ≤1, e.g., sulfuric acid, is added and the mixture is heated at reflux to complete conversion. After the cooling to preferably 10 to 40° C., more preferably 20 to 30° C., particularly preferably to 23 to 25° C. in step P1.iii., the reaction solution is diluted with a nonpolar aprotic solvent, such as methyl tert-butyl ether (MTBE), and vigorously mixed. In step P1.iv., the phase insoluble in the solvent is separated and dissolved in water. This aqueous solution, in a second reaction stage P2., is admixed in step P2.i. with an alkali metal salt of the dye anion and with an ester solvent, such as butyl acetate, to form an ester solvent/water mixture, which is stirred in step P2.ii. with gentle heating, preferably to a maximum of 50° C., more preferably to a maximum of 40° C. The phases are separated in step P2.iii. and the organic phase is washed with water. After removal of the solvent, preferably by heating to 40 to 70° C. and drying under reduced pressure, at preferably 10 to 50 mbar, in step P2.iv. the product is obtained as a highly viscous oil.

If, according to the process above, the crude product precipitates as a solid after the first stage P1., it is filtered off, washed with a nonpolar aprotic solvent, such as MTBE, and used as a purified product together with water in the second stage.

If, according to the process above, the crude product does not dissolve in water, the oily phase containing crude product is washed with a nonpolar aprotic solvent, such as MTBE. The product purified in this way is further processed together with water in the second stage P2.

A further subject of the invention relates to the use of the benzopyrylium dye according to the invention, preferably as part of a two-component photoinitiator system, in photocurable formulations in combination with a suitable electron donor for improving the bleachability of photocurable materials. The benzopyrylium dyes according to the invention are preferably utilized after irradiation with actinic radiation for initiating radical polymerizations. Electron donors selected from triarylalkyl borates, trifluoroalkyl borates, tertiary amines, pentacoordinated silicates and dihydropyridines are preferred for use here. Preferably, the benzopyrylium dye according to the invention is used together with the electron donor in a three-component photoinitiator system together with an electron acceptor selected from iodonium salts, sulfonium salts, trichlorotriazines, electron-deficient trihalomethylaromatics and Katritzky salts, or a mixture of at least two thereof. The electron-deficient trihalomethylaromatics are preferably trichloromethylaromatics with strongly electronegative substituents, for example at least one fluorine atom, as described in Examples 1-9 in WO 2015/091427 on pages 19-22. Particularly preferred for utilization are triarylalkyl borates as electron donors with the benzopyrylium dyes according to the invention as a photoinitiation system. Corresponding triarylalkyl borates are known from U.S. Ser. No. 11/098,066, in particular those as described on page 47 in Example 26.

Especially preferably, these trialkyl borate salts are selected from the following structures, where n is selected between 1 and 2 and K⁺ is any monovalent cation:

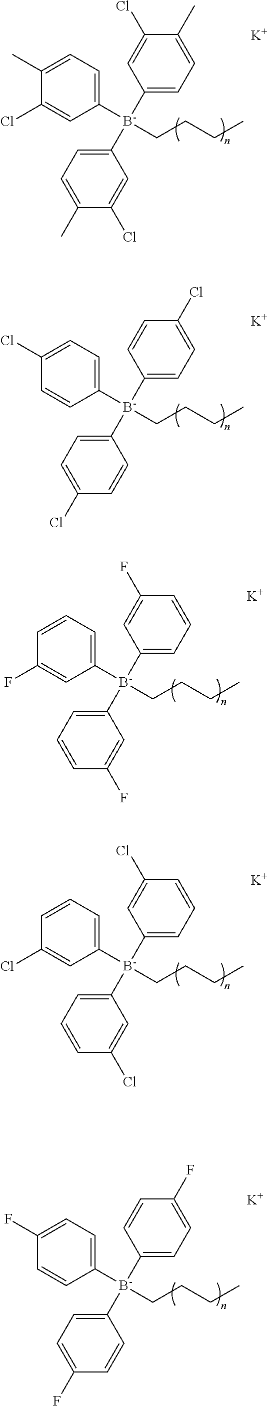

Preferably, the benzopyrylium dyes according to the invention are used as part of a three-component photoinitiation system in which an electron acceptor is added in addition to the type II photoinitiation systems described above. The electron acceptor is preferably selected from iodonium salts, sulfonium salts, trichlorotriazines, the trichloroaromatics described in WO 2015/091427, or Katritzky salts.

A further subject of the invention relates to a photopolymer composition containing at least a) matrix polymers, b) writing monomers, c) a non-photopolymerizable component, d) a photoinitiator system (PIS), at least comprising a suitable co-initiator and a benzopyrylium dye according to the invention, in the form of the benzopyrylium salt of the formula (I), and also optionally e) catalysts, radical stabilizers, solvents, additives and other auxiliaries and/or adjuvants.

As matrix polymers a), writing monomers b) and non-photopolymerizable component c), and also PIS d), all components known in each case to the skilled person for this purpose can be used. The matrix polymers a) are known for example from the prior art of U.S. Pat. No. 8,921,012, the writing monomers b) are known for example from the prior art of US2010086860, U.S. Pat. No. 8,222,314 and U.S. Ser. No. 10/241,402, the non-photopolymerizable component c) and also the PIS d) are known for example from the prior art of U.S. Ser. No. 10/001,703 and U.S. Pat. No. 9,146,456, and the optional non-photopolymerizable component c) is known for example from the prior art of U.S. Pat. No. 8,999,608. Optional component e) used may be any of the catalysts, radical stabilizers, solvents, additives and other auxiliaries and/or adjuvants known to the skilled person for this purpose.

Preferred matrix polymers a) of low refractive index are, for example, polyurethanes obtainable by reaction of a polyol component with a polyisocyanate component.

Preferably, the writing monomer b) comprises or consists of at least one mono- and/or one polyfunctional writing monomer. Further preferably, the writing monomer b) may comprise or consist of at least one mono- and/or one polyfunctional (meth)acrylate writing monomer. Especially preferably, the writing monomer may comprise or consist of at least one mono- and/or one polyfunctional urethane (meth)acrylate.

The at least one non-photopolymerizable component c) may be any component c) which the skilled person would select for the photopolymer composition according to the invention.

The at least one photoinitiator system d) can be any photoinitiator system which the skilled person would select for the photopolymer composition according to the invention. Photoinitiators of component d) are typically compounds activatable by actinic radiation that are able to trigger polymerization of the writing monomers. The photoinitiators can be differentiated as unimolecular (type I) and bimolecular (type II) initiators. In addition, they are distinguished in terms of their chemical nature as photoinitiators for radical, anionic, cationic or mixed modes of polymerization.

Type I photoinitiators (Norrish type I) for radical photopolymerization on irradiation form free radicals through unimolecular bond scission. Examples of type I photoinitiators are triazines, oximes, benzoin ethers, benzil ketals, bis-imidazoles, aroylphosphine oxides, sulfonium salts and iodonium salts.

Type II photoinitiators (Norrish type II) for radical polymerization consist of a dye as sensitizer and a co-initiator and undergo a bimolecular reaction when irradiated with light adapted to the dye. First, the dye absorbs a photon and is able from its excited state to undergo a bimolecular reaction with a suitable co-initiator. The latter releases the polymerization-initiating radicals through electron or proton transfer or direct hydrogen abstraction.

The type II photoinitiators are preferably used. Additionally preferred photoinitiator systems d) are described in principle in EP 0 223 587 A and preferably consist of a mixture of one or more dyes.

It is preferably provided that the photopolymer composition additionally contains urethanes as additives of component c), where the urethanes can be substituted in particular by at least one fluorine atom.

Likewise, the benzopyrylium dyes according to the invention can also be used in cured photopolymers, which are characterized analogously to the photopolymer compositions described above.

All information on the benzopyrylium dyes according to the invention, in the form of the benzopyrylium salt of the formula (I), and also the selection of the associated anions Anⁿ⁻, are to be applied in analogy to the observations on the benzopyrylium salt of the formula (I) according to the invention for the use.

Another subject of the present invention relates to a layer structure containing at least the following layers:
A. a substrate layer A., which may be part of a further layer structure,
B. a photopolymer layer B., containing the photopolymer composition according to the invention, and
C. optionally an outer layer C., which may be part of the further layer structure.

The photopolymer composition has the same components, fractions of components and properties as the aforedescribed photopolymer composition according to the invention. The layer structure may comprise further layers. Preferably, the substrate layer A. and the outer layer C. have an adhesive layer on at least one of the two surfaces, so that the substrate layer A. or the outer layer C. can be connected to the polymer layer B. or a further exterior layer.

Another subject of the present invention relates to a layer structure containing at least the following layers:
A. a substrate layer A., which may be part of a further layer structure,
B. a cured photopolymer layer B′., produced from the photopolymer composition according to the invention by curing by means of light, and
C. optionally an outer layer C., which may be part of the further layer structure.

The photopolymer composition has the same components, fractions of components and properties as the aforedescribed photopolymer composition according to the invention. The layer structure may comprise further layers. Preferably, the substrate layer A. and the outer layer C. have an adhesive layer on at least one of the two surfaces, so that the substrate layer A. or the outer layer C. can be connected to the cured polymer layer B′. or a further exterior layer.

Another subject of the invention relates to a holographic medium comprising a benzopyrylium dye according to the invention or a benzopyrylium dye prepared by the process according to the invention, or a photopolymer composition according to the invention. Also disclosed, furthermore, is a process for producing a holographic medium using the benzopyrylium dye according to the invention, for example in the form of the aforedescribed photopolymer composition comprising the benzopyrylium dye according to the invention. The dye according to the invention or the photopolymer compositions according to the invention can be used in particular for producing holographic media in the form of a film. In this case, as carrier, in the form of the substrate layer A., a stratum of a material or material assembly transparent for light in the visible and NIR spectral range (transmission greater than 85% in the wavelength range from 400 to 1200 nm) is coated in the dark with the photopolymer composition B. on one or both sides and, optionally, with a covering layer C. applied on the one or more photopolymer strata B. Preferred materials or material assemblies for the carrier, in the form of the substrate layer A., are based on polycarbonate (PC), polyethylene terephthalate (PET), polybutylene terephthalate, polyethylene, polypropylene, cellulose acetate, cellulose hydrate, cellulose nitrate, cycloolefin polymers, polystyrene, polyepoxides, polysulfone, cellulose triacetate (CTA), polyamide, polyimide, polymethyl methacrylate, polyvinyl chloride, polyvinyl butyral or polydicyclopentadiene, or mixtures thereof. They are more preferably based on PC, PET and CTA. Material assemblies may be film laminates or coextrudates. Preferred material assemblies are duplex and triplex films constructed according to one of the schemes A./B., A./B./A. or A./B./C. Particular preference is given to PC/PET, PET/PC/PET and PC/TPU (TPU=thermoplastic polyurethane). The materials or material assemblies of the carrier, in the form of the substrate layer A., may have been given a nonstick, antistatic, hydrophobizing or hydrophilizing finish on one or both sides. Likewise, the materials or material assemblies may have been activated primarily by plasma pretreatment or UV light irradiation. The stated modifications are used on the side facing the photopolymer layer B. for the purpose that the photopolymer layer B. either adheres more strongly to the substrate layer A. or, on the contrary, can be detached from the substrate layer A. without destruction. A modification of the side of the carrier, in the form of the substrate layer A., facing away from the photopolymer stratum B. serves to ensure that the media according to the invention meet specific mechanical requirements, which are required, for example, for processing in roll laminators, in particular in roll-to-roll processes. The outer layer C. preferably has the same materials, properties and composition as the substrate layer A. and is preferably produced in the same manner as the substrate layer A.

In addition, a further process is disclosed for producing a holographic medium using a benzopyrylium dye according to the invention, in particular in the form of the aforedescribed photopolymer composition comprising at least the benzopyrylium dye, said process also providing holographic media in the form of films or layer structures. In this case, as substrate layer A., a stratum of a material or material assembly transparent for light in the visible and NIR spectral range (transmission greater than 85% in the wavelength range from 400 to 1200 nm) is applied in the dark with the photopolymer composition B. on one side via 2D printing and, optionally, with a covering layer C. on the one or more photopolymer strata B. All common inkjet technologies can be used here. Optionally, in a targeted way, only the regions required for the function can be printed with the photopolymer composition B. Preferred materials or material assemblies of the carrier are based on glass, silicon (in the form of the highly polished wafers known from semiconductor technology), polycarbonate (PC), polyethylene terephthalate (PET), polybutylene terephthalate, polyethylene, polypropylene, cellulose acetate, cellulose hydrate, cellulose nitrate, cycloolefin polymers, polystyrene, polyepoxides, polysulfone, cellulose triacetate (CTA), polyamide, polymethyl methacrylate, polyvinyl chloride, polyvinyl butyral or polydicyclopentadiene or mixtures thereof. They are more preferably based on PC, PET and CTA. Material assemblies may be film laminates or coextrudates. Preferred material assemblies are duplex and triplex films constructed according to one of the schemes A./B., A./B./A. or A./B./C. Particular preference is given to PC/PET, PET/PC/PET and PC/TPU (TPU=thermoplastic polyurethane). The materials or material assemblies of the carrier may have been given a non-stick, antistatic, hydrophobized or hydrophilized finish on one or both sides. The stated modifications are used on the side facing the photopolymer layer B. for the purpose that the photopolymer stratum B. can be detached from the carrier, in the form of the substrate layer A., without destruction. A modification of the side of the carrier facing away from the photopolymer stratum B. serves to ensure that the media according to the invention meet specific mechanical requirements, which are required, for example, for processing in roll laminators, in particular in roll-to-roll processes.

Further preferred are material assemblies according to the type described above, comprising a light-cured photopolymer layer B′, thus forming duplex and triplex films according to a scheme A./B′., A./B′./A. or A./B′./C.

In addition, a further process is disclosed for producing a holographic medium using a benzopyrylium dye according to the invention, in particular in the form of the aforedescribed photopolymer composition comprising at least the benzopyrylium dye, said process also providing holographic media in the form of a glass (D.) or acrylic (E.) composite. In the dark, the photopolymer composition here is embedded directly between two layers of glass or acrylic. This is preferably done by a method selected from the group consisting of injecting the photopolymer composition into a cavity of two glass or acrylic surfaces, by applying to a glass or acrylic surface by means of spraying, knife coating or immersion, nozzle, roll or spin coating or laminating a free photopolymer film and covering it with a second glass or acrylic surface. Preferred is a D./B./D., D./B./E., E./B./D., E./B./E., D./B./A. or E./B./A. layer structure, where D. stands for a glass layer and E. for an acrylic layer. The layers D. and E. are preferably nonstick, hydrophobizing or hydrophilizing. The stated modifications are used on the side facing the photopolymer layer B. for the purpose that the photopolymer stratum B. either adheres more strongly to the surfaces facing D. or E. or, on the contrary, can be detached from the surface without destruction. Further preferred are glass or acrylic assemblies according to the type described above, comprising a light-cured photopolymer layer B′., so that an assembly is formed according to the scheme D./B′./D., D./B′./E., E./B′./D., E./B′./E., D./B′./A. or E./B′./A.

Holographic information in the form of a hologram can be incorporated into such holographic media by exposure.

The holographic media according to the invention can be processed by corresponding exposure procedures for optical applications in the NIR and in the entire visible and near-UV range (350-1500 nm) to give holograms. Holograms embrace all holograms that can be recorded by processes known to the skilled person.

Another subject of the invention relates to a hologram obtainable from the holographic medium according to the invention. As described above, the hologram is obtained by appropriately exposing the holographic medium.

A preferred embodiment of the hologram is selected from the group consisting of off-axis holograms, full-aperture transfer holograms, white-light transmission holograms (“rainbow holograms”), Denisyuk holograms, off-axis reflection holograms, edge-lit holograms and holographic stereograms. Reflection holograms, Denisyuk holograms, transmission holograms or a combination of at least two thereof are preferred. Preferably, combinations of these hologram types or multiple holograms of the same type are independently united in the same volume of the holographic medium, also known as multiplexing.

Possible optical functions of the holograms which can be produced with the photopolymer compositions comprising at least one benzopyrylium dye according to the invention correspond to the optical functions of light elements such as lenses, mirrors, deflecting mirrors, filters, diffuser lenses, diffraction elements, diffusers, waveguides, light guides, projection lenses and/or masks. It is likewise possible for combinations of these optical functions to be combined in one hologram independently of each other. Often these optical elements show a frequency selectivity, depending on how the holograms were exposed and what dimensions the hologram has.

In addition, it is also possible by means of the holographic media to produce holographic images or representations in hologram form, as for example for personal portraits, biometric representations in security documents, or generally images or image structures for advertising, security labels, brand protection, branding, labels, design elements, decorations, illustrations, collectible cards, pictures and the like, and pictures that can represent digital data, including in combination with the products detailed above. Holographic images can have the impression of a three-dimensional image, but they can also represent image sequences, short films or a number of different objects, depending on the angle at which, on the (possibly moving) light source with which, etc., they are illuminated.

Another subject of the invention relates to an optical display comprising a holographic medium according to the invention or a hologram according to the invention.

Another subject of the invention relates to the use of the photopolymer composition according to the invention for producing a holographic medium or a hologram.

Above-described functions of the holograms producible with the benzopyrylium dye according to the invention or the photopolymer compositions according to the invention are used for example, but not exclusively, in the areas of eye tracking, sensing, and also LIDAR and augmented reality, head-mounted display and virtual reality applications in the NIR range.

Another subject of the invention relates to the use of a holographic medium according to the invention for producing chip cards, identity documents, 3D images, product protection tags, labels, banknotes or holographically optical elements, in particular for optical displays or in media for the realization of methods selected from the group consisting of eye tracking, sensing, LIDAR, augmented reality, head-mounted display, head-up display and virtual reality applications, in particular in the near infrared range, and a combination of at least two thereof.

The holographic media can be used for recording of in-line, off-axis, full-aperture transfer, white-light transmission, Denisyuk, off-axis reflection or edge-lit holograms and also holographic stereograms, especially for production of optical elements, images or image representations.

Holograms are accessible preferably from holographic media according to the invention by means of exposure.

### Examples

The following examples are used to explain the invention by way of illustration without limiting it to them.

### Measurement Methods:

OH number: The specified OH numbers were determined in accordance with DIN 53240-2-2007-11.
NCO value: The specified NCO values (isocyanate contents) were determined in accordance with DIN EN ISO 11909-2007-05.

### Measurement of the Holographic Properties DE and an of the Holographic Media by Means of Two-Beam Interference in a Reflection Arrangement:

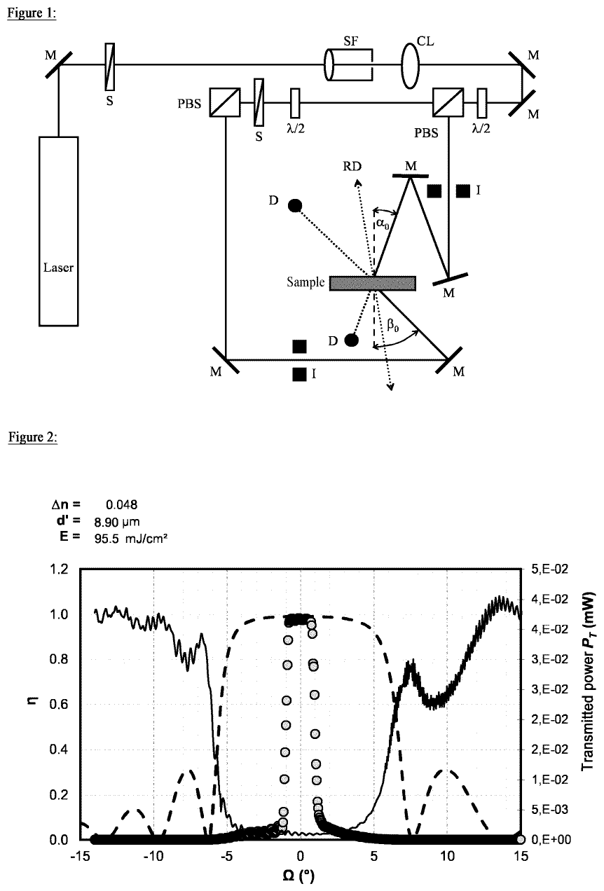

As shown in FIG. 1, the beam of a blue DPSS laser with the emission wavelength λ in a vacuum of 457 nm was converted into a parallel homogeneous beam using the spatial filter (SF) and together with the collimating lens (CL). The final cross sections of the signal and reference beam were fixed by the iris diaphragms (I). The diameter of the iris aperture was 0.4 cm. The polarization-dependent beam splitters (PBS) divided the laser beam into two coherent, equally polarized beams. By means of the λ/2 plates, the power of the reference beam was set to 0.5 mW and the power of the signal beam to 0.65 mW. The powers were determined using the semiconductor detectors (D) with the sample removed. The angle of incidence (α₀) of the reference beam was −22.0°; the angle of incidence (β₀) of the signal beam was 42.0°. The angles were measured proceeding from the sample normal to the beam direction. According to FIG. 1, therefore, α₀ had a negative sign and Do a positive sign. At the location of the sample (holographic medium), the interference field of the two overlapping beams produced a grating of light and dark stripes perpendicular to the angle bisector of the two beams incident on the sample (reflection hologram). The stripe spacing A, also called grating period, in the holographic medium was ˜225 nm (the refractive index of the holographic medium assumed to be −1.504).

FIG. 1 shows the holographic test setup with which the diffraction efficiency (DE) of the holographic media was measured, where FIG. 1 depicts the geometry of a holographic media tester (HMT) at λ=457 nm (DPSS laser): M=mirror, S=shutter, SF=spatial filter, CL=collimator lens, λ/2=λ/2 plate, PBS=polarization-sensitive beam splitter, D=detector, I=iris diaphragm, α₀=−22°, β₀=42° are the angles of incidence of the coherent beams measured outside the sample (outside the holographic medium), and RD=reference direction of the turntable.

Holograms were written into the holographic medium in the following manner:
Both shutters (S) are opened for the exposure time t.
Thereafter, the holographic medium was left for 5 minutes' time for the diffusion of the as yet unpolymerized writing monomers, with closed shutters (S).

The written holograms were then read out in the following manner. The shutter of the signal beam remained closed. The shutter of the reference beam was open. The iris diaphragm of the reference beam was closed to a diameter of <1 mm. This ensured that the beam was always completely within the previously written hologram for all angles of rotation (Ω) of the holographic medium. The turntable, under computer control, then swept over the angle range from Ωₘᵢₙ to Qₘₐₓ with an angle step width of 0.05°. Ω was measured from the sample normal to the reference direction of the turntable. The reference direction of the turntable was obtained when the angles of incidence of the reference beam and of the signal beam had the same absolute value during writing of the hologram, i.e., α₀=−32° and β₀=32°. Then Ω_{recording} was =0°. For α₀=−22.0° and β₀=42.0°, Ω_{recording} was therefore 10°. In general, for the interference field during writing (“recording”) of the hologram:

$${α}_{0} = {θ}_{0} + {Ω}_{recording} . \qquad ( 2 )$$

θ₀ was the half-angle in the laboratory system outside the holographic medium, and, during writing of the hologram:

$${θ}_{0} = \frac{{α}_{0} - {β}_{0}}{2} . \qquad ( 3 )$$

Thus, in this case, θ₀=−32°. At each setting for the angle of rotation Ω, the powers of the beam transmitted in the zeroth order were measured by means of the corresponding detector D, and the powers of the beam diffracted into the first order by means of the detector D. The diffraction efficiency η was calculated at each setting of angle Ω as the quotient of:

$$η = \frac{{P}_{D}}{{P}_{D} + {P}_{T}} \qquad ( 4 )$$

P_{D} is the power in the detector of the diffracted beam and P_{T} is the power in the detector of the transmitted beam.

By means of the method described above, the Bragg curve, which describes the diffraction efficiency q as a function of the rotation angle Ω, of the written hologram, was measured and stored in a computer. In addition, the intensity transmitted into the zeroth order was also recorded against the rotation angle Ω and stored in a computer.

The maximum diffraction efficiency (DE=ηₘₐₓ) of the hologram, i.e., the peak value thereof, was determined at Ω_{reconstruction}. In some cases, it was necessary for this purpose to change the position of the detector for the diffracted beam in order to determine this maximum value.

The refractive index contrast Δn and the thickness d of the photopolymer layer (i.e., of the sample or the holographic medium) were then determined using the Coupled Wave Theory (see: H. Kogelnik, The Bell System Technical Journal, volume 48, November 1969, number 9, page 2909-page 2947) from the measured Bragg curve and the angular profile of the transmitted intensity. In this context, it should be noted that, because of the shrinkage in thickness which occurs as a result of the photopolymerization, the stripe spacing Λ′ of the hologram and the orientation of the stripes (slant) may differ from the stripe spacing A of the interference pattern and the orientation thereof. Accordingly, the angle α₀′ and the corresponding angle of the turntable Ω_{reconstruction}, at which maximum diffraction efficiency is achieved will also differ from α₀ and from the corresponding Ω_{recording}. This alters the Bragg condition. This alteration is taken into account in the evaluation process. The evaluation process is described hereinafter:

All geometric parameters which relate to the recorded hologram and not to the interference pattern are shown as parameters with primes.

For the Bragg curve η(Ω) of a reflection hologram, according to Kogelnik:

$$η = \{ \begin{matrix}\frac{1}{1 - \frac{1 - {( ξ / v )}^{2}}{{sin}^{2} ( \sqrt{{ξ}^{2} - {v}^{2}} )}} , when {v}^{2} - {ξ}^{2} < 0 \\ \frac{1}{1 + \frac{1 - {( ξ / v )}^{2}}{{sinh}^{2} ( \sqrt{{v}^{2} - {ξ}^{2}} )}} , when {v}^{2} - {ξ}^{2} \geq 0\end{matrix} \qquad ( 5 )$$

$$with :$$

$$v = \frac{π \cdot Δ n \cdot {d}^{′}}{λ \cdot \sqrt{\vert {c}_{s} \cdot {c}_{r} \vert}} \qquad ( 6 )$$

$$ξ = - \frac{{d}^{′}}{2 \cdot {c}_{s}} \cdot DP \qquad ( 7 )$$

$${c}_{s} = cos ( {ϑ}^{′} ) - cos ( {ψ}^{′} ) \cdot \frac{λ}{n \cdot {Λ}^{′}} \qquad ( 8 )$$

$${c}_{r} = cos ( {ϑ}^{′} ) \qquad ( 9 )$$

$$DP = \frac{π}{{Λ}^{′}} \cdot ( 2 \cdot cos ( {ψ}^{′} - {ϑ}^{′} ) - \frac{λ}{n \cdot {Λ}^{′}} ) \qquad ( 10 )$$

$${ψ}^{′} = \frac{{β}^{′} + {α}^{′}}{2} \qquad ( 11 )$$

$${Λ}^{′} = \frac{λ}{2 \cdot n \cdot cos ( {ψ}^{′} - {α}^{′} )} \qquad ( 12 )$$

The following holds for the reading out (“reconstruction”) of the hologram, similarly to the above explanation:

$${ϑ}_{0}^{′} = {θ}_{0} + Ω \qquad ( 13 )$$

$$sin ( {ϑ}_{0}^{′} ) = n \cdot sin ( {ϑ}^{′} ) \qquad ( 14 )$$

At the Bragg condition, the “dephasing” is DP=0. And it follows correspondingly that:

$${α}_{0}^{′} = {θ}_{0} + {Ω}_{reconstruction} \qquad ( 15 )$$

$$sin ( {α}_{0}^{′} ) = n \cdot sin ( {α}^{′} ) \qquad ( 16 )$$

The as yet unknown angle β′ can be determined from the comparison of the Bragg condition of the interference field in the course of writing of the hologram and the Bragg condition in the course of reconstruction of the hologram, assuming that only shrinkage in thickness takes place. It then follows that:

$$sin ( {β}^{′} ) = \frac{1}{n} \cdot [ sin ( {α}_{0} ) + sin ( {β}_{0} ) - sin ( {θ}_{0} + {Ω}_{reconstruction} ) ] \qquad ( 17 )$$

v is the grating intensity, ζ is the detuning parameter, and ψ′ is the orientation (slant) of the refractive index grating that was written. α′ and β′ correspond to the angles α₀ and β₀ of the interference field on writing of the hologram, but measured in the holographic medium and valid for the grating of the hologram (after shrinkage of thickness). n is the mean refractive index of the photopolymer and was set at 1.504. k is the wavelength of the laser light in a vacuum.

The maximum diffraction efficiency (DE=ηₘₐₓ) when ζ0 is then obtained as:

$$DE = {tanh}^{2} ( v ) = {tanh}^{2} ( \frac{π \cdot Δ n \cdot {d}^{′}}{λ \cdot \sqrt{cos ( {α}^{′} ) \cdot ( cos ( {α}^{′} - 2 {ψ}^{′} )}} ) \qquad ( 18 )$$

The measured data for the diffraction efficiency, the theoretical Bragg curve and the transmitted intensity are, as shown in FIG. 2, plotted against the centered angle of rotation ΔΩ≡Ω_{reconstruction}−Ω=α₀′−ϑ₀′, also called angle detuning (x-axis). FIG. 2 shows the measured transmitted power P_{T} (right-hand y-axis) plotted as a solid line (here of Example 5) against the angle detuning ΔΩ, the measured diffraction efficiency η (left-hand y-axis) plotted as filled circles against the angle detuning ΔΩ (to the extent allowed by the finite size of the detector), and the fitting to the Kogelnik theory as a broken line (left-hand y-axis).

As DE is known, the shape of the theoretical Bragg curve according to Kogelnik is only determined by the thickness d′ of the photopolymer layer. Δn is corrected via DE for given thickness d′ in such a way that measurement and theory of DE always match. d′ is now adjusted until the angular positions of the first minor minima of the theoretical Bragg curve correspond to the angular positions of the first minor maxima of the transmitted intensity and also until the full width at half maximum (FWHM) for the theoretical Bragg curve and for the transmitted intensity match.

Since the direction in which a reflection hologram also rotates when reconstructed by means of an Ω scan, but the detector for the diffracted light can cover only a finite angle range, the Bragg curve of broad holograms (small d′) is not fully covered in an Ω scan, but rather only the central region, given suitable detector positioning. Therefore, the shape of the transmitted intensity, which is complementary to the Bragg curve, is additionally employed for adjustment of the layer thickness d′.

FIG. 2 shows the plot of the Bragg curve η according to the Coupled Wave Theory (broken line), the measured diffraction efficiency (filled circles) and the transmitted power (black solid line) against the angle detuning ΔΩ.

For a formulation, this procedure may have been repeated multiple times for different exposure times t on different holographic media in order to determine that mean energy dose of the incident laser beam at which DE passes into the saturation value on writing of the hologram. The mean energy dose E is calculated as follows from the powers of the two component beams assigned to the angles α₀ and β₀ (reference beam where Pᵣ=1.31 mW and signal beam where Pₛ=1.69 mW), the exposure time t and the diameter of the iris diaphragm (0.4 cm):

$$E ( mJ / {cm}^{2} ) = \frac{2 \cdot [ {P}_{r} + {P}_{s} ] \cdot t ( s )}{π \cdot {0.4}^{2} {cm}^{2}} \qquad ( 19 )$$

The powers of the component beams were adjusted such that the same power density is attained in the holographic medium at the angles α₀ and β₀ used.

### Substances:

The solvents, reagents and all bromoaromatics used were purchased from chemical suppliers. The bromoaromatics were freshly distilled where appropriate. Anhydrous solvents contain <50 ppm of water.

| | |
|---|---|
| Polyol 1 | was prepared like polyol 1 described in WO2015091427, with an OH |
| | number of 56.8. |
| Desmodur ® N 3900 | product of Covestro AG, Leverkusen, DE, hexane diisocyanate-based |
| | polyisocyanate, iminooxadiazinedione fraction at least 30%, NCO content: |
| | 23.5%. |
| Fomrez ® UL-28 | urethanization catalyst, commercial product of Momentive Performance |
| | Chemicals, Wilton, CT, USA. |
| Urethane acrylate 1 | (phosphorothioyltris(oxybenzene-4,1-diylcarbamoyloxyethane-2,1-diyl) |
| | trisacrylate, [CAS No. 1072454-85-3]) was prepared as described in |
| | WO2015091427. |
| Urethane acrylate 2 | (2-({[3-(methylsulfanyl)phenyl]carbamoyl}oxy)-ethyl prop-2-enoate, |
| | [CAS No. 1207339-61-4]) was prepared as described in WO2015091427. |
| Additive 1 | (bis(2,2,3,3,4,4,5,5,6,6,7,7-dodecafluoroheptyl)-(2,2,4-trimethylhexane- |
| | 1,6-diyl)biscarbamate [CAS No. 1799437-41-4]) was prepared as |
| | described in WO2015091427. |
| Co-initiator 1 | (N-benzyl-N,N-dimethylhexadecylammonium tris-(3-chloro-4- |
| | methylphenyl)hexylborate, [CAS No. 1702465-82-4]) was prepared from |
| | 1-bromo-3-chlorobenzene, diisopropyl-hexylboronic acid ester and N- |
| | benzyl-N,N-dimethylhexadecyl-ammonium chloride as described in |
| | WO2018087064. |
| BYK-310 | silicone-containing surface additive, product of BYK-Chemie GmbH, |
| | Wesel, Germany. |
| Dye 1 | benzopyrylium dye 5,6-dihydro-3,10-dimethoxy-7- |
| | phenylbenzo[c]xanthylium perchlorate [CAS No. 126634-30-8], sourced |
| | from Synthon Chemicals GmbH & Co. KG, Bitterfeld-Wolfen, Germany. |
| Dye 2 | (1,3,3-trimethyl-2-[2-(1-methyl-2-phenyl-1H-indol-3-yl)ethenyl]-3H- |
| | indolium bis(2-ethylhexyl)sulfosuccinate [CAS No. 1374689-54-9]) was |
| | prepared as described in WO2012062655. |
| Dye 3 | 2-[2-[4-[(2-chloroethyl)methylamino]phenyl]ethenyl]-1,3,3-trimethyl- |
| | 3H-indolium bis(2-ethylhexyl)sulfosuccinate [CAS No. 153952-28-4] was |
| | prepared as described in WO2012062655. |

### Synthesis Protocols:

Preparation protocol A (for benzopyrylium salts with R²⁰⁰, R²⁰⁴, R²⁰⁵, R²⁰⁷ and R²⁰⁸=H and any R²⁰¹ other than NR₂):

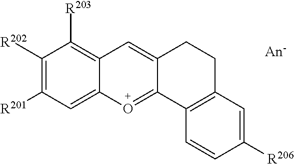

The corresponding 2-hydroxyarylaldehyde derivative (1.0 eq) was dissolved together with the corresponding tetralone derivative (1.0 eq) in glacial acetic acid (0.4 M). Sulfuric acid (2.0 eq) is slowly added and the mixture is heated at reflux for 1 h. After the cooling to room temperature, the reaction solution is added to methyl tert-butyl ether (MTBE). The resulting solid is filtered off and the reaction product is washed with MTBE (2×) and dried under reduced pressure. The reaction product is then dissolved together with the corresponding sodium salt of the dye anion (1.0 eq) at 50° C. in butyl acetate/water mixture (1:1) and stirred intensively overnight. The phases are separated and the organic phase is washed with water (deionized, 6×). Removing the solvent in vacuo and drying the residue under reduced pressure afford the product as a highly viscous oil.

Preparation Protocol B (for Benzopyrylium Bis(2-Ethylhexyl)Sulfosuccinates with R²⁰⁰, R²⁰³, R²⁰⁵, R²⁰⁷ and R²⁰⁸=H and R²⁰⁴=Ph):

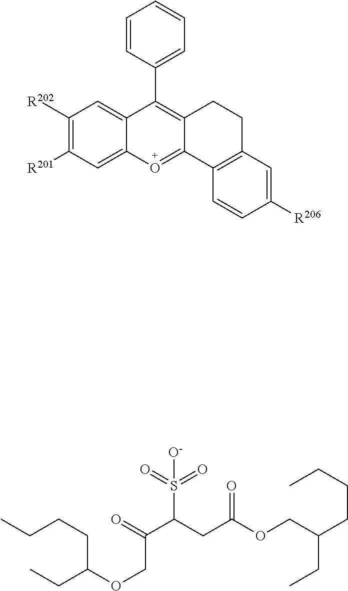

The corresponding 2-hydroxybenzophenone derivative (1.0 eq) is dissolved together with the corresponding tetralone derivative (1.0 eq) in glacial acetic acid (0.4 M). Sulfuric acid (2.0 eq) is slowly added and the mixture is heated at reflux for at least 8 h. After the cooling to room temperature, the reaction solution is added to methyl tert-butyl ether (MTBE) and the product settles out as an insoluble oil. The ether phase is separated off and the oily phase is washed several times with MTBE. The product is dissolved together with sodium bis(2-ethylhexyl)sulfosuccinate at 50° C. in butyl acetate/water mixture (1:1) and stirred intensively overnight. The phases are separated and the organic phase is washed with water (deionized, 6×). Removing the solvent in vacuo and drying the residue under reduced pressure afford the product as a highly viscous oil.

Preparation Protocol C (for benzopyrylium bis(2-ethylhexyl)sulfosuccinates with R²⁰⁰, R²⁰², R²⁰³, R²⁰⁴, R²⁰⁵, R²⁰⁷ and R²⁰⁸=H and R²⁰1=NEt₂):

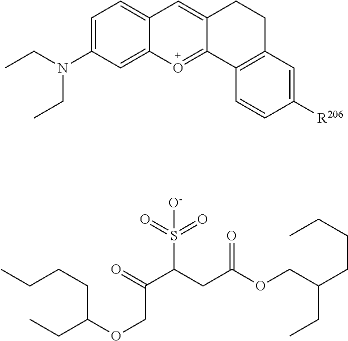

4-Diethylaminosalicylaldehyde (1.0 eq) is dissolved together with the corresponding tetralone derivative (1.0 eq) in glacial acetic acid (0.4 M). Sulfuric acid (2.0 eq) is slowly added and the mixture is heated at reflux for 1 h. After the cooling to room temperature, the reaction solution is added to methyl tert-butyl ether (MTBE) and the product settles out as an insoluble oil. The ether phase is separated off and the product is taken up in water (deionized). The aqueous phase is washed with MTBE (3×) and finally stirred intensively overnight with a butyl acetate solution of sodium bis(2-ethylhexyl)sulfosuccinate (0.9 eq) as a two-phase mixture. The phases are separated and the organic phase is washed with water (deionized, 6×). Removing the solvent in vacuo and drying the residue under reduced pressure afford the product.

### Preparation Protocol D (for Photopolymer Film/Holographic Media):

5.85 g of the above-described polyol component 1 were melted and mixed in the dark with 2.16 g of the urethane acrylate 1, 6.48 g of the above-described urethane acrylate 2, 5.4 g of the above-described fluorinated urethane (additive 1), 0.43 g of the above-described co-initiator 1, 0.11 g of the respective dye, 0.07 g of BYK 310, 0.02 g of Fomrez® UL-28 and 8.4 g of ethyl acetate, to give a clear solution. This was followed by addition of 1.08 g Desmodur® N 3900 and renewed mixing. This solution was placed in the dark on a roll-to-roll coating line onto a 60 μm thick TAC film and applied by means of a doctor blade in such a way that a wet film thickness range of 12-14 μm was achieved. With a drying temperature of 120° C. and a drying time of 4 minutes, the coated film was dried and then protected with a polyethylene film of 40 μm in thickness. Subsequently, this film was light-imperviously packaged.

### EXAMPLES

### Example 1: Preparation of 12,13-dihydro-10-methoxydibenzo[a,h]xanthylium bis(2-ethylhexyl) sulfosuccinate and Preparation of the Holographic Medium Containing 12,13-dihydro-10-methoxydibenzo[a,h]xanthylium bis(2-ethylhexyl)sulfosuccinate

In accordance with general preparation protocol A, 2-hydroxynaphthaldehyde was reacted with 6-methoxy-1-tetralone and sodium bis(2-ethylhexyl)sulfosuccinate was used for the ion exchange. A highly viscous red oil (1.81 g, 72% of theory over two stages) was obtained. In accordance with preparation protocol D, a holographic medium containing this benzopyrylium dye was produced.

¹H NMR (600 MHz, CDCl₃): δ 10.39 (s, 1H), 9.18 (d, J=8.4 Hz, 1H), 8.44 (d, J=9.2 Hz, 1H), 8.36 (d, J=8.8 Hz, 1H), 8.06 (ddd, J=11.0, 7.5, 2.0 Hz, 2H), 7.99 (d, J=9.2 Hz, 1H), 7.83 (ddd, J=8.1, 7.0, 1.0 Hz, 1H), 7.12-7.07 (m, 1H), 6.96 (d, J=2.4 Hz, 1H), 4.25-4.20 (m, 1H), 4.03-3.87 (m, 7H), 3.71 (t, J=7.5 Hz, 2H), 3.34-3.25 (m, 3H), 3.14 (dd, J=17.6, 3.3 Hz, 1H), 1.54-1.48 (m, 2H), 1.34-1.17 (m, 16H), 0.91-0.79 (m, 12H).
Absorption maximum (in acetone): 479-490 nm.

### Example 2: Preparation of 5,6-dihydro-3,9,10-trimethoxybenzo[c]xanthylium bis(2-ethylhexyl) sulfosuccinate and Preparation of the Holographic Medium Containing 5,6-dihydro-3,9,10-trimethoxybenzo[c]xanthylium bis(2-ethylhexyl)sulfosuccinate

In accordance with general preparation protocol A, 2-hydroxy-4,5-dimethoxybenzaldehyde was reacted with 6-methoxy-1-tetralone and sodium bis(2-ethylhexyl)sulfosuccinate was used for the ion exchange. A highly viscous orange oil (2.3 g, 90% of theory over two stages) was obtained. In accordance with preparation protocol D, a holographic medium containing this benzopyrylium dye was produced.

¹H NMR (600 MHz, CDCl₃): δ 9.17 (s, 1H), 8.45 (d, J=8.8 Hz, 1H), 7.70 (d, J=9.8 Hz, 2H), 7.10 (dd, J=8.8, 2.5 Hz, 1H), 6.86 (d, J=2.4 Hz, 1H), 4.23 (dd, J=11.7, 3.4 Hz, 1H), 4.14 (s, 3H), 4.01-3.91 (m, 10H), 3.34-3.24 (m, 3H), 3.17-3.08 (m, 3H), 1.53 (pd, J=6.0, 1.9 Hz, 2H), 1.36-1.19 (m, 16H), 0.90-0.80 (m, 12H).
Absorption maximum (in acetone): 480-492 nm.

### Example 3: Preparation of 10-(diethylamino)-5,6-dihydro-3-methoxybenzo[c]xanthylium bis(2-ethylhexyl)Sulfosuccinate and Preparation of the Holographic Medium Containing 10-(diethylamino)-5,6-dihydro-3-methoxybenzo[c]xanthylium bis(2-ethylhexyl)sulfosuccinate

In accordance with general preparation protocol C, 6-methoxy-1-tetralone was reacted. A highly viscous violet oil (1.2 g, 76% of theory over two stages) was obtained. In accordance with preparation protocol D, a holographic medium containing this benzopyrylium dye was produced.

¹H NMR (600 MHz, CDCl₃): δ 8.98 (s, 1H), 8.24 (d, J=9.4 Hz, 1H), 8.17 (d, J=8.8 Hz, 1H), 7.22 (dd, J=9.4, 2.5 Hz, 1H), 7.00 (dd, J=8.8, 2.5 Hz, 1H), 6.91 (dd, J=2.4, 0.8 Hz, 1H), 6.86 (d, J=2.4 Hz, 1H), 4.22 (dd, J=11.9, 3.1 Hz, 1H), 4.06 (s, 7H), 3.64 (q, J=7.2 Hz, 4H), 3.38 (dd, J=17.6, 12.0 Hz, 1H), 3.24-3.16 (m, 3H), 3.07 (dd, J=8.8, 6.5 Hz, 2H), 1.57-1.48 (m, 2H), 1.38-1.18 (m, 22H), 0.89-0.83 (m, 12H).

Absorption Maximum (in Acetone): 543-572 nm.

### Example 4: Preparation of 10-(Diethylamino)-5,6-Dihydrobenzo[c]Xanthylium Bis-(2-Ethylhexyl) sulfosuccinate and Preparation of the Holographic Medium Containing 10-(diethylamino)-5,6-dihydrobenzo[c]xanthylium bis(2-ethylhexyl)sulfosuccinate

In accordance with general preparation protocol C, 1-tetralone was reacted. A highly viscous violet oil (1.4 g, 64% of theory over two stages) was obtained. In accordance with preparation protocol D, a holographic medium containing this benzopyrylium dye was produced.

¹H NMR (600 MHz, CDCl₃): δ 8.93 (s, 1H), 8.22 (d, J=9.5 Hz, 1H), 8.16 (dd, J=7.8, 1.3 Hz, 1H), 7.52 (td, J=7.5, 1.4 Hz, 1H), 7.46 (td, J=7.6, 1.2 Hz, 1H), 7.32 (dd, J=7.6, 1.2 Hz, 1H), 7.28 (dd, J=9.4, 2.4 Hz, 1H), 6.96-6.91 (m, 1H), 4.19 (dd, J=11.9, 3.2 Hz, 1H), 4.04 (s, 4H), 3.66 (q, J=7.2 Hz, 4H), 3.31 (dd, J=17.6, 11.9 Hz, 1H), 3.20-3.11 (m, 3H), 3.06 (dd, J=8.9, 6.6 Hz, 2H), 1.55-1.46 (m, 2H), 1.36-1.16 (m, 22H), 0.89-0.76 (m, 12H).

Absorption maximum (in acetone): 527-554 nm.

### Example 5: Preparation of 5,6-dihydro-3,10-dimethoxy-7-phenylbenzo[c]XANTHYLIUM bis(2-ethylhexyl)Sulfosuccinate and Preparation of the Holographic Medium Containing 5,6-dihydro-3,10-dimethoxy-7-phenylbenzo[c]xanthylium bis(2-ethylhexyl)sulfosuccinate

In accordance with general preparation protocol B, 2-hydroxy-4-methoxybenzophenone was reacted with 6-methoxy-1-tetralone for 22 h at 140° C. A dark red solid (1.8 g, 76% of theory over two stages) was obtained. In accordance with preparation protocol D, a holographic medium containing this benzopyrylium dye was produced.

¹H NMR (600 MHz, CDCl₃): δ 8.74 (d, J=8.9 Hz, 1H), 8.00 (d, J=2.4 Hz, 1H), 7.65-7.61 (m, 3H), 7.42 (d, J=9.2 Hz, 1H), 7.41-7.38 (m, 2H), 7.18 (ddd, J=9.2, 4.5, 2.5 Hz, 2H), 6.85 (d, J=2.4 Hz, 1H), 4.19-4.10 (m, 4H), 4.03-3.88 (m, 7H), 3.24-3.16 (m, 1H), 3.06-3.00 (m, 4H), 2.95-2.90 (m, 1H), 1.54-1.48 (m, 2H), 1.38-1.18 (m, 16H), 0.91-0.80 (m, 12H).
Absorption maximum (in acetone): 471-481 nm.

### Example 6: Preparation of 5,6-dihydro-3,10-dimethoxybenzo[c]xanthylium bis(2-ethylhexyl)Sulfosuccinate and Preparation of the Holographic Medium Containing 5,6-dihydro-3,10-dimethoxybenzo[c]xanthylium bis(2-ethylhexyl)sulfosuccinate

In accordance with general preparation protocol A, 4-methoxysalicylaldehyde was reacted with 6-methoxy-1-tetralone and sodium bis-(2-ethylhexyl)sulfosuccinate was used for the ion exchange. A red solid (2.0 g, 74% of theory over two stages) was obtained. In accordance with preparation protocol D, a holographic medium containing this benzopyrylium dye was produced.

¹H NMR (600 MHz, CDCl₃): δ 9.21 (s, 1H), 8.48 (d, J=8.9 Hz, 1H), 8.16 (d, J=9.0 Hz, 1H), 7.69 (d, J=2.3 Hz, 1H), 7.19 (dd, J=9.0, 2.3 Hz, 1H), 7.09 (dd, J=8.9, 2.5 Hz, 1H), 6.85 (d, J=2.4 Hz, 1H), 4.21 (dd, J=11.8, 3.3 Hz, 1H), 4.09-3.89 (m, 10H), 3.35-3.24 (m, 3H), 3.17-3.07 (m, 3H), 1.57-1.48 (m, 2H), 1.34-1.17 (m, 16H), 0.89-0.79 (m, 12H).

Absorption maximum (in acetone): 466-479 nm.

### Example 7: Preparation of 5,6-dihydro-3-methoxy-9-methyl-7-phenylbenzo[c]xanthylium bis(2-ethylhexyl)Sulfosuccinate and Preparation of the Holographic Medium Containing 5,6-dihydro-3-methoxy-9-methyl-7-phenylbenzo[c]xanthylium bis(2-ethylhexyl)sulfosuccinate

In accordance with general preparation protocol B, 2-hydroxy-5-methylbenzophenone was reacted with 6-methoxy-1-tetralone for 12 h. A brown solid (0.98 g, 35% of theory over two stages) was obtained. In accordance with preparation protocol D, a holographic medium containing this benzopyrylium dye was produced.

¹H NMR (600 MHz, CDCl₃): δ 8.60 (d, J=8.9 Hz, 1H), 8.21 (d, J=8.7 Hz, 1H), 7.87 (dd, J=8.7, 2.0 Hz, 1H), 7.68-7.61 (m, 3H), 7.48-7.43 (m, 2H), 7.29 (dd, J=2.1, 1.0 Hz, 1H), 7.14 (dd, J=9.0, 2.4 Hz, 1H), 6.96 (d, J=2.4 Hz, 1H), 4.02-3.83 (m, 8H), 3.20-3.12 (m, 3H), 3.04 (dd, J=8.2, 6.0 Hz, 2H), 2.95 (dd, J=17.5, 2.9 Hz, 1H), 2.45 (s, 3H), 1.52-1.45 (m, 2H), 1.32-1.17 (m, 16H), 0.87-0.79 (m, 12H).

Absorption maximum (in acetone): 455-464 nm.

### Example 8: Preparation of 5,6-dihydro-3-methoxy-10-methylbenzo[c]xanthylium bis(2-ethylhexyl)Sulfosuccinate and Preparation of the Holographic Medium Containing 5,6-dihydro-3-methoxy-10-methylbenzo[c]xanthylium bis(2-ethylhexyl)sulfosuccinate

In accordance with general preparation protocol A, 2-hydroxy-4-methylbenzaldehyde was reacted with 6-methoxy-1-tetralone and sodium bis(2-ethylhexyl)sulfosuccinate was used for the ion exchange. A highly viscous brown oil (1.7 g, 66% of theory over two stages) was obtained. In accordance with preparation protocol D, a holographic medium containing this benzopyrylium dye was produced.

¹H NMR (600 MHz, CDCl₃): δ 9.56 (d, J=1.0 Hz, 1H), 8.33 (dd, J=8.6, 6.0 Hz, 2H), 7.82 (d, J=1.5 Hz, 1H), 7.63-7.59 (m, 1H), 7.08 (dd, J=8.9, 2.5 Hz, 1H), 6.95 (dd, J=2.4, 1.1 Hz, 1H), 4.17 (ddd, J=11.8, 3.3, 0.7 Hz, 1H), 4.05-3.88 (m, 7H), 3.50-3.46 (m, 2H), 3.30-3.20 (m, 3H), 3.10 (dd, J=17.5, 3.3 Hz, 1H), 2.68 (s, 3H), 1.58-1.49 (m, 2H), 1.35-1.20 (m, 16H), 0.90-0.82 (m, 12H).

Absorption maximum (in acetone): 458-463 nm.

### Example 9: Preparation of 12,13-dihydrodibenzo[a,h]xanthylium bis(2-ethylhexyl)sulfosuccinate and Preparation of the Holographic Medium Containing 12,13-dihydrodibenzo[a,h]xanthylium bis(2-ethylhexyl)sulfosuccinate

In accordance with general preparation protocol A, 2-hydroxynaphthaldehyde was reacted with 1-tetralone and sodium bis(2-ethylhexyl)sulfosuccinate was used for the ion exchange. An orange solid (0.84 g, 49% of theory over two stages) was obtained. In accordance with preparation protocol D, a holographic medium containing this benzopyrylium dye was produced.

¹H NMR (600 MHz, CDCl₃): δ 10.71 (s, 1H), 9.28 (d, J=8.3 Hz, 1H), 8.54 (d, J=9.2 Hz, 1H), 8.37 (dd, J=7.9, 1.2 Hz, 1H), 8.12-8.03 (m, 3H), 7.85 (ddd, J=8.1, 7.1, 1.0 Hz, 1H), 7.73 (td, J=7.5, 1.3 Hz, 1H), 7.62-7.56 (m, 1H), 7.49 (d, J=7.6 Hz, 1H), 4.23-4.19 (m, 1H), 4.04-3.88 (m, 4H), 3.77 (dd, J=8.3, 6.9 Hz, 2H), 3.34-3.25 (m, 3H), 3.13 (dd, J=17.5, 3.3 Hz, 1H), 1.52 (p, J=5.7 Hz, 2H), 1.34-1.16 (m, 16H), 0.91-0.78 (m, 12H).

Absorption maximum (in acetone): 460-462 nm.

### Example 10: Preparation of 5,6-dihydro-3-methoxy-7-phenylbenzo[c]xanthylium bis(2-ethylhexyl)Sulfosuccinate and Preparation of the Holographic Medium Containing 5,6-dihydro-3-methoxy-7-phenylbenzo[c]xanthylium bis(2-ethylhexyl)sulfosuccinate

In accordance with general preparation protocol B, 2-hydroxybenzophenone was reacted with 6-methoxy-1-tetralone for 8 h. A highly viscous, dark orange oil (0.84 g, 27% of theory over two stages) was obtained.

In accordance with preparation protocol D, a holographic medium containing this benzopyrylium dye was produced.

¹H NMR (600 MHz, CDCl₃): δ 8.65 (d, J=8.9 Hz, 1H), 8.31 (d, J=8.5 Hz, 1H), 8.07 (ddd, J=8.6, 7.0, 1.5 Hz, 1H), 7.69-7.61 (m, 4H), 7.59 (dd, J=8.3, 1.4 Hz, 1H), 7.50-7.46 (m, 2H), 7.19 (dd, J=8.9, 2.4 Hz, 1H), 6.97 (d, J=2.3 Hz, 1H), 4.12-4.05 (m, 1H), 4.05-3.85 (m, 7H), 3.18-3.06 (m, 5H), 2.98-2.92 (m, 1H), 1.54-1.47 (m, 2H), 1.36 (s, 16H), 0.91-0.80 (m, 12H).

Absorption maximum (in acetone): 455-463 nm.

### Example 11: Preparation of 5,6-dihydro-3-methoxy-9-methylbenzo[c]xanthylium bis(2-ethylhexyl)Sulfosuccinate and Preparation of the Holographic Medium Containing 5,6-dihydro-3-methoxy-9-methylbenzo[c]xanthylium bis(2-ethylhexyl)sulfosuccinate

In accordance with general preparation protocol A, 2-hydroxy-5-methylbenzaldehyde was reacted with 6-methoxy-1-tetralone and sodium bis(2-ethylhexyl)sulfosuccinate was used for the ion exchange. A brown solid (2.2 g, 86% of theory over two stages) was obtained. In accordance with preparation protocol D, a holographic medium containing this benzopyrylium dye was produced.

¹H NMR (600 MHz, CDCl₃): δ 9.51 (d, J=1.1 Hz, 1H), 8.36 (d, J=8.9 Hz, 1H), 8.16 (t, J=1.5 Hz, 1H), 7.92 (d, J=8.7 Hz, 1H), 7.84 (dd, J=8.8, 2.1 Hz, 1H), 7.08 (dd, J=8.9, 2.5 Hz, 1H), 6.96 (d, J=2.4 Hz, 1H), 4.18 (dd, J=11.8, 3.3 Hz, 1H), 4.10-3.88 (m, 7H), 3.53-3.48 (m, 2H), 3.30-3.21 (m, 3H), 3.10 (dd, J=17.5, 3.3 Hz, 1H), 2.60 (s, 3H), 1.56-1.49 (m, 2H), 1.36-1.20 (m, 16H), 0.91-0.81 (m, 12H).

Absorption maximum (in acetone): 455-462 nm.

### Example 12: Preparation of 5,6-dihydro-3,10-dimethoxybenzo[c]xanthylium dodecylbenzenesulfonate And Preparation of the Holographic Medium Containing 5,6-dihydro-3,10-dimethoxybenzo[c]xanthylium dodecylbenzenesulfonate

In accordance with general preparation protocol A, 4-methoxysalicylaldehyde was reacted with 6-methoxy-1-tetralone and sodium dodecylbenzenesulfonate was used for the ion exchange. A highly viscous, red-brown oil (0.41 g, 33% of theory over two stages) was obtained. In accordance with preparation protocol D, a holographic medium containing this benzopyrylium dye was produced.

¹H NMR (600 MHz, CDCl₃): δ 9.62 (s, 1H), 8.48 (d, J=8.9 Hz, 1H), 8.38 (d, J=9.0 Hz, 1H), 7.86 (d, J=7.7 Hz, 2H), 7.65-7.62 (m, 1H), 7.34 (dd, J=9.0, 2.4 Hz, 1H), 7.08 (s, 3H), 6.90 (d, J=2.5 Hz, 1H), 4.10 (s, 3H), 3.98 (s, 3H), 3.42 (t, J=7.6 Hz, 2H), 3.16 (t, J=7.6 Hz, 2H), 1.52-1.44 (m, 1H), 1.32-1.01 (m, 18H), 0.88-0.79 (m, 6H).

Absorption maximum (in acetone): 472-481 nm.

### Example 13: Preparation of 5,6-dihydro-3,10-dimethoxybenzo[c]xanthylium tetraphenylborate and Preparation of the Holographic Medium Containing 5,6-dihydro-3,10-dimethoxybenzo[c]xanthylium tetraphenylborate

In accordance with general preparation protocol A, 4-methoxysalicylaldehyde was reacted with 6-methoxy-1-tetralone and sodium tetraphenylborate was used for the ion exchange. An orange solid (0.41 g, 33% of theory over two stages) was obtained. In accordance with preparation protocol D, a holographic medium containing this benzopyrylium dye was produced.

¹H NMR (600 MHz, CDCl₃): δ 8.10 (d, J=8.9 Hz, 1H), 7.50-7.43 (m, 9H), 7.19 (dd, J=8.9, 2.4 Hz, 1H), 7.16 (d, J=2.4 Hz, 1H), 6.99-6.92 (m, 10H), 6.85 (d, J=2.5 Hz, 1H), 6.78-6.74 (m, 4H), 3.98 (s, 3H), 3.98 (s, 3H), 2.91 (t, J=7.6 Hz, 2H), 2.70 (t, J=7.6 Hz, 2H).

Absorption maximum (in acetone): 471-482 nm.

### Noninvention Example 1 (NIE-1): Production of the Holographic Medium Containing 5,6-dihydro-3,10-dimethoxy-7-phenylbenzo[c]xanthylium perchlorate

In accordance with preparation protocol D, a holographic medium containing the dye 1 described above was produced.

### Noninvention Example 2 (NIE-2): Production of a holographic medium containing 1,3,3-trimethyl-2-[2-(1-methyl-2-phenyl-1H-indol-3-yl)ethenyl]-3H-indolium bis(2-ethylhexyl)sulfosuccinate

In accordance with preparation protocol D, a holographic medium containing the dye 2 described above was produced.

### Noninvention Example 3 (NIE-3): Production of a Holographic Medium Containing 2-[2-[4-[(2-chloroeth yl)methylamino]phenyl]ethenyl]-1,3,3-trimethyl-3H-indolium bis(2-ethylhexyl)sulfosuccinate

In accordance with preparation protocol D, a holographic medium containing the dye 3 described above was produced.

### Evaluation of the Invention Dyes and Noninvention Dyes:

One requirement for the photopolymer films produced here is the highest possible transmission over the entire visible spectral range from 400 nm to 800 nm. The higher the transmission, the better the bleachability. Another requirement for the photopolymer films produced here is that of optical and chemical homogeneity, i.e., no turbidity or the like may occur. If no turbidity or optical inhomogeneities in the photopolymer film can be detected by optical inspection of the films, the dyes in question are potentially usable for holographic media.

To be able to evaluate and compare the bleachability of the photopolymer composition, the holographic media were tested in exactly the same way: For each example, a sample was bleached for 180 s under blanket light irradiation by a metal halide lamp and in the next step a transmission spectrum of 400 nm to 800 nm was recorded. The bleachability of the photopolymer films containing different benzopyrylium dyes was calculated using the following formula (1) with the experimentally recorded data of the transmission spectrum:

$$Bleachability := {\int }_{400 nm}^{800 nm} 100 \% transmission - {\int }_{400 nm}^{800 nm} Experimental transmission curve = 40000 - {\int }_{400 nm}^{800 nm} Experimental transmission curve \qquad ( 1 )$$

The following bleachability values and optical assessments of the invention examples and noninvention examples were determined:

TABLE 1
Calculated bleachability values based on the experimentally
determined transmission curves of the UV-light-bleached
photopolymer films, and observation as to whether crystals
have formed in the photopolymer film.

| | | Optical rating of the photopolymer |
|---|---|---|
| | | film |
| Ex. | Bleachability | (turbid vs. clear) |
| 1 | 3163 | clear |
| 2 | 3259 | clear |
| 3 | 3532 | clear |
| 4 | 3419 | clear |
| 5 | 3212 | clear |
| 6 | 3410 | clear |
| 7 | 3127 | clear |
| 8 | 3134 | clear |
| 9 | 3311 | clear |
| 10 | 3045 | clear |
| 11 | 3063 | clear |
| 12 | 3546 | clear |
| 14 | 3127 | clear |
| NIE1 | 3149 | turbid |
| NIE2 | 3548 | clear |
| NIE3 | 3670 | clear |

The results obtained show that the required properties of bleachability and optical clarity/homogeneity of a photopolymer are achieved with the benzopyrylium dyes according to the invention. The bleachability values of the new and invention-compliant benzopyrylium dyes (Examples 1 to 14) are all lower than those of the two cyanine dyes/hemicyanine dyes of the noninvention examples NIE-2 and NIE-3. In addition, turbidity or optical inhomogeneities were not observed in any of the invention examples, but in the example NIE-1, which contains a benzopyrylium cation but combined with a perchlorate anion and thus is non-invention-compliant.

The noninvention examples NIE1, NIE2 and NIE3 fail in at least one required property and are therefore unsuitable for providing the required properties.

In addition, by way of example, the holographic performance Δn of some films was illustratively tested by means of the above-described measurement of the photopolymer films via two-beam interference in a reflection arrangement. The measurement results are summarized in Table 2 below.

TABLE 2
Results of the holographic performance measurement by means of two-
beam interference in a reflection arrangement according to the test
setup described above and calculation for some examples.

| Ex. | Δnₘₐₓ (@exposure time & dose value) |
|---|---|
| 2 | 0.050 (8 s, 95 mJ/cm²) |
| 5 | 0.048 (8 s, 95 mJ/cm²) |
| 7 | 0.050 (16 s, 191 mJ/cm²) |
| 10 | 0.048 (16 s, 191 mJ/cm²) |
| NIE-2 | 0.049 (16 s, 191 mJ/cm²) |

Based on the results of the Δnₘₐₓdetermination from Table 2, it is clear that the new benzopyrylium dyes can be used very well in combination with trialkylarylborate salts in two-component photoinitiator systems, in photopolymers and holographic media. The holographic performance is at least as good as that which can be achieved with known cyanine dyes, as a comparison of Δnₘₐₓ determination of Examples 2, 5, 7 and 10 with NIE-2 shows.

1. A benzopyrylium dye of the formula (I) 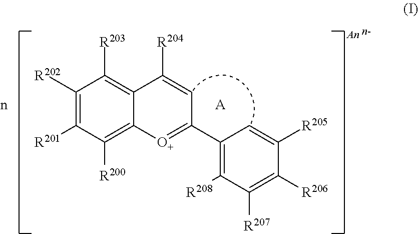
in which
R²⁰⁰, R²⁰¹, R²⁰², R²⁰³, R²⁰⁴, R²⁰⁵, R²⁰⁶, R²⁰⁷ and R²⁰⁸ independently of one another are each hydrogen, alkyl, cycloalkyl, aralkyl, aryl, (het)aryl, hydroxyl, alkoxy or dialkylamino,
A is a —CH₂— or a —CH₂—CH₂— bridge, and
the anion Anⁿ⁻ has a molecular weight of ≥200 g/mol and does not contain a halogen atom and n is 1 to 3.

2. The benzopyrylium dye as claimed in claim 1, wherein R²⁰⁰, R²⁰⁵, R²⁰⁷ and R²⁰⁸ are hydrogen, A is a-CH₂—CH₂— bridge, and
R²⁰⁴ is a radical selected from the group consisting of hydrogen, C₁ to C₄ alkyl, or an arbitrarily substituted (het)aryl radical.

3. The benzopyrylium dye as claimed in claim 1, wherein R²⁰⁰, R²⁰⁵, R²⁰⁷ and R²⁰⁸ are hydrogen atoms, A is a-CH₂—CH₂— bridge,
R²⁰¹ is selected from the group consisting of hydrogen, C₁ to C₄ alkyl, hydroxyl, C₁ to C₄ alkoxy, or dialkylamino, the dialkylamino being selected from the group consisting of diethylamino, dimethylamino, diisopropylamino, a six-membered saturated ring attached via the N of the amino group, which may additionally contain an N or O and may be substituted by nonionic arbitrary radicals, or a combination of at least two thereof,
R²⁰² is hydrogen, C₁ to C₄ alkyl, hydroxyl or C₁ to C₄ alkoxy,
R²⁰³ either is hydrogen or together with R²⁰² forms a —CH═CH—CH═CH— bridge,
R²⁰⁴ is hydrogen, C₁ to C₄ alkyl or an arbitrarily substituted (het)aryl radical, and
R²⁰⁶ is hydrogen, hydroxyl or C₁ to C₄ alkoxy.

4. The benzopyrylium dye as claimed in claim 1, wherein the anion Anⁿ⁻ is selected from the group consisting of C₈ to C₂₅ alkanesulfonates, C₉ to C₂₅ alkanoates, C₉ to C₂₅ alkenoates, C₈ to C₂₅ alkyl sulfates, C₈ to C₂₅ alkenyl sulfates, polyether sulfates based on at least 5 equivalents of ethylene oxide or 5 equivalents of propylene oxide, bis-C₄ to C₂₅ alkyl-, C₅ to C₇ cycloalkyl-, C₃ to C₈ alkenyl- or C₇ to C₁₁ aralkyl-sulfosuccinates, C₈ to C₂₅ alkyl sulfoacetates, benzenesulfonates substituted by at least one radical of the group C₄ to C₂₅ alkyl and/or C₁ to C₁₂ alkoxycarbonyl, naphthalene- or biphenylsulfonates optionally substituted by nitro, cyano, hydroxyl, C₁ to C₂₅ alkyl, C₁ to C₁₂ alkoxy, amino or C₁ to C₁₂ alkoxycarbonyl, benzene-, naphthalene- or biphenyldisulfonates optionally substituted by nitro, cyano, hydroxyl, C₁ to C₂₅ alkyl, C₁ to C₁₂ alkoxy or C₁ to C₁₂ alkoxycarbonyl, benzoates substituted by dinitro, C₆ to C₂₅ alkyl, C₄ to C₁₂ alkoxycarbonyl, benzoyl or toluoyl, or a mixture of at least two thereof.

5. The benzopyrylium dye of claim 1, wherein the anion Anⁿ⁻ is selected from the group consisting of C₈ to C₂₅ alkanesulfonates, C₈ to C₂₅ alkyl sulfates, bis-C₄ to C₂₅ alkyl-, C₈ to C₇ cycloalkyl-, C₃ to C₈ alkenyl- or C₇ to C₁₁ aralkyl-sulfosuccinates, C₈ to C₂₅ alkyl sulfoacetates, benzenesulfonates substituted by at least one radical from the group C₄ to C₂₅ alkyl and/or C₁ to C₁₂ alkoxycarbonyl, and tetraphenyl borates, or a combination of at least two thereof.

6. A process for preparing a benzopyrylium dye according to claim 1, comprising a multistage reaction sequence in which
A. in a first reaction stage P1., at least the following steps are performed:
P1.i. dissolving a correspondingly selected 2-hydroxyarylcarbonyl derivative together with a corresponding indanone or tetralone derivative in a weak acid,
P1.ii. heating the mixture from P1.i. with the addition of a strong acid,
P1.iii. cooling and washing the mixture from P1.ii. with a nonpolar aprotic solvent,
P1.iv. separating the phase insoluble in the nonpolar aprotic solvent and taking up this phase in water;
B. in a second reaction stage P2., at least the following steps are performed:
P2.i. adding an alkali metal salt of the dye anion Anⁿ⁻ and a nonpolar aprotic solvent to the aqueous solution from P1.iv.,
P2.ii. stirring and optionally heating the mixture from P2.i. and removing the aqueous phase and discarding it, including the salts contained,
P2.iii. washing the mixture from P2.ii. with water, and
P2.iv. removing the solvent, optionally under reduced pressure, and drying the benzopyrylium dye, optionally under reduced pressure.

7. A method for preparing photocurable formulations in combination with an electron donor for improving the bleachability of photocurable materials comprising a benzopyrylium dye as claimed in claim 1.

8. A photopolymer composition comprising a) matrix polymers, b) writing monomers, c) a non-photopolymerizable component, d) a photoinitiator system, at least comprising a suitable co-initiator and a benzopyrylium dye as claimed in claim 1.

9. A layer structure containing at least the following layers:
A. a substrate layer A.,
B. a photopolymer layer B., containing a photopolymer composition as claimed in claim 8, and
C. optionally an outer layer C.

10. A layer structure containing at least the following layers:
A. a substrate layer A.,
B. an exposed photopolymer layer B′., produced from the photopolymer composition as claimed in claim 8 by exposure by means of light, and
C. optionally an outer layer C.

11. A holographic medium comprising a benzopyrylium dye as claimed in claim 1.

12. A hologram obtainable from a holographic medium as claimed in claim 10.

13. The hologram as claimed in claim 12, wherein the hologram is selected from the group consisting of a reflection, transmission, in-line, off-axis, full-aperture transfer, white-light transmission, Denisyuk, off-axis reflection or edge-lit hologram and a holographic stereogram, or a combination of at least two thereof.

14. An optical display comprising a holographic medium as claimed in claim 11.

15. A method for producing a holographic medium or a hologram comprising providing the photopolymer composition as claimed in claim 8.

16. A method for producing chip cards, identity documents, 3D images, product protection tags, labels, banknotes or holographically optical elements, or a combination of at least two thereof, the method comprising providing a holographic medium as claimed in claim 11.
